(19) United States
(12) Patent Application Publication
(10) Pub. No.: US 2020/0172186 A1
(43) Pub. Date: Jun. 4, 2020

(54) PERCUSSION BELL INTENDED FOR BEING ATTACHED TO THE HANDLEBAR OF A BICYCLE

(71) Applicant: DECATHLON, Villeneuve d'Ascq (FR)

(72) Inventors: Colin GALLOIS, Villeneuve d'Ascq (FR); Lancelot DURAND, Villeneuve d'Ascq (FR)

(21) Appl. No.: 16/487,292

(22) PCT Filed: Feb. 20, 2018
(86) PCT No.: PCT/FR2018/050401

§ 371 Date: Aug. 20, 2019

(30) Foreign Application Priority Data
Feb. 22, 2017 (FR) 1751399

(51) Int. Cl. B62J 3/04; G10K 1/10; G10K 1/072; G10K 1/26

(52) U.S. Cl. CPC B62J 3/04; G10K 1/26; G10K 1/072; G10K 1/10

(57) ABSTRACT

The invention relates to a percussion bell comprising a bell and a hammer mounted on a base provided with a collar for clamping around a mounting. The collar being arranged with an installation axis (A′) of the mounting, a sagittal installation plane (M′) containing the outermost portion of the collar, as well as a transverse plane (T) perpendicular to the installation plane (M′) and containing the installation axis (A′). The hammer has a central portion rotatably mounted on the base and topped by an upper tab provided with a percussion area. The hammer also has a lower tab for movement provided with an actuating area, the percussion area extends above the transverse plane (T), and the actuating area extends below the transverse plane by being offset outwards relative to the installation plane (M′).

### CROSS-REFERENCE TO RELATED APPLICATIONS

This application claims the benefit of International application number PCT/FR2018/050401, filed Feb. 20, 2018 and French patent application number 1751399, filed on Feb. 22, 2017, the entire contents of which are incorporated herein by reference.

### TECHNICAL FIELD

The invention relates to a percussion bell intended for being attached to a support, in particular the handlebar of a bicycle.

Such bells are known and comprise a ringer and a clapper that are mounted on a base equipped with a clamping collar for clamping the bell about the support, the clapper being capable of being manually moved over a path of travel for stressing a resilient member arranged such that it actuates the subsequent displacement of the clapper over a path for striking the ringer.

In particular, the clapper can have a central portion that is mounted such that it rotates on the base about an axis, in addition to a first striking lug for striking the ringer, and a second displacement lug that extends laterally on either side of the central portion. The resilient member is positioned between the clapper and the base such that a manual pressing action on the displacement lug distances the striking lug from the ringer while stressing the resilient member, whereby the release of the pressing action actuates the striking movement causing the striking lug to strike the ringer.

The bells are generally fastened near a handle, in particular against the brake ring, in order to allow the cyclist to actuate them using his/her thumb while limiting the loss of grip on the handle, and thus the loss of symmetrical holding of the handlebar, therefore easing the use thereof when cycling.

In order to improve the clapper actuation ergonomics, a known method involves equipping the base with a lateral extension on which the central portion of the clapper is mounted such that it rotates under stress from the resilient member, in order to laterally offset the rotational axis of the clapper relative to the base, and thus relative to the ringer, while bringing the clapper closer to the handle of the handlebar, and in particular the actuating lug thereof closer to the thumb of the cyclist.

For example, document EP-0 008 841 discloses a bell, the clapper of which is mounted such that it is laterally offset on the base along a vertical rotational axis, the striking and displacement lugs extending on either side of the central portion in substantially horizontal directions.

Moreover, document CN-104 691 662 discloses a bell, the clapper of which is mounted such that it is laterally offset on the base along a rotational axis that extends substantially parallel to an axis of revolution of the clamping collar, the central portion of the clapper being positioned beneath an upper striking lug that extends in a vertical plane in a direction perpendicular to the rotational axis, the clapper also having a lower displacement lug that extends beneath the central portion.

However, these solutions are not entirely satisfactory since the displacement lug is still located relatively far away from the cyclist's thumb. In particular, given the small size of a child's hand, he/she is required to release his/her grip on the handle in order to use the bell, which is detrimental to his/her safety since the child finds it difficult to simultaneously signal his/her presence using the bell and manoeuvre the handlebar and/or use the brake to avoid a potential hazard.

### SUMMARY OF THE INVENTION

The purpose of the invention is to perfect the prior art by proposing a bell that can be actuated in a simple and ergonomic manner, in particular while preventing the cyclist from having to change his/her grip on the handle, which allows the cyclist, in particular when this is a child, to use the bell to signal his/her presence while remaining able to brake and/or steer the handlebar.

For this purpose, the invention relates to a percussion bell intended to be secured to a support, in particular the handlebar of a bicycle, the bell comprising a ringer and a clapper that are mounted on a base equipped with a clamping collar for clamping the bell about the support, the collar being arranged such that it defines an assembly axis of the support, a sagittal assembly plane containing the part of the collar located the furthest outwards, in addition to a transverse plane perpendicular to the assembly plane and containing the assembly axis, the clapper being capable of being manually moved over a path of travel for stressing a resilient member that is arranged such that it actuates the subsequent displacement of the clapper over a path for striking the ringer, the clapper having a central portion that is mounted such that it rotates on the base, the central portion being positioned below an upper lug provided with a percussion area, the clapper also having a lower displacement lug provided with an actuating area, the resilient member being positioned between the clapper and the base such that a pressing action on the actuating area distances the percussion area from the ringer, while stressing the resilient member, the release of the pressing action actuating the striking movement generating the striking of the ringer by the percussion area, the percussion area extending above the transverse plane, the actuating area extending below the transverse plane by being offset in the outwards direction relative to the assembly plane.

### BRIEF DESCRIPTION OF THE DRAWINGS

Other features and advantages of the invention can be clearly observed in the following description, which is given with reference to the accompanying figures, in which:

FIGS. 1a and 1b show a bell according to the invention, respectively a rear view (FIG. 1a) and a median section (FIG. 1b) thereof, wherein the fastening means of the clamping collar are uncoupled from the additional fastening means of the ringer;

FIGS. 2a and 2b show the bell in FIG. 1 in the partially-disassembled state, respectively a rear view (FIG. 2a) and a median section (FIG. 2b) thereof, wherein the tip of the collar is positioned in the receiving housing thereof;

FIGS. 3a, 3b and 3c show the bell in the previous figures, respectively a rear view (FIG. 3a), a median section (FIG. 3b) and a side view (FIG. 3c) thereof, wherein the fastening means of the clamping collar are secured to the additional fastening means of the ringer;

FIG. 4 shows a front view of the bell in FIG. 3.

With reference to these figures, the invention discloses a percussive bell intended to be secured to a support, in particular the handlebar of a bicycle.

### DETAILED DESCRIPTION

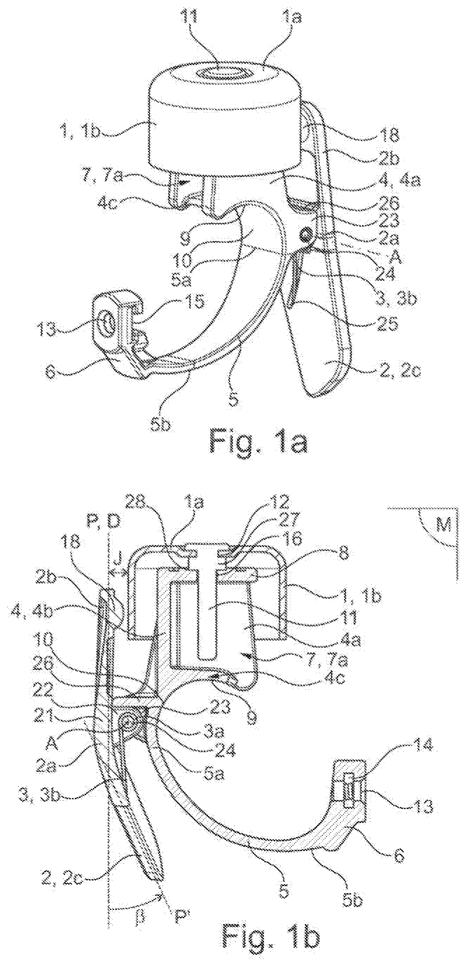

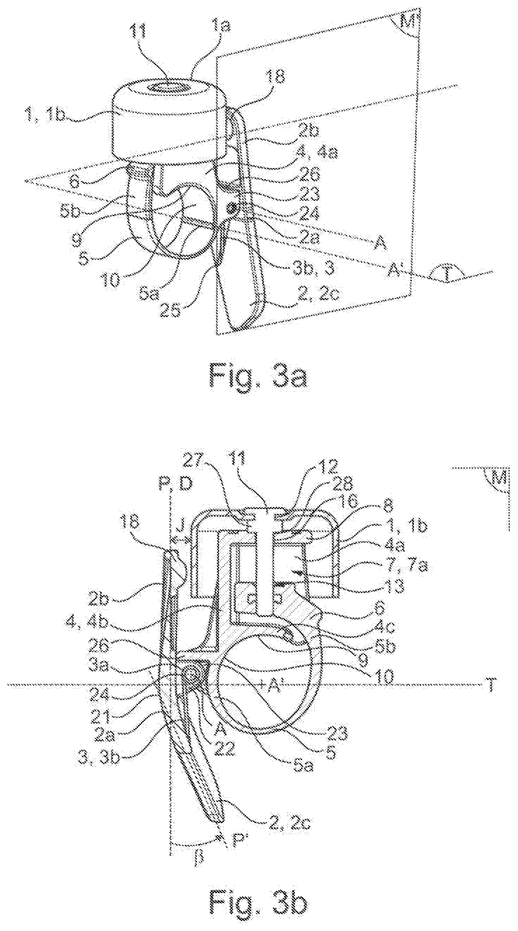

In this description, the terms describing the spatial positioning are taken with reference to the position of the bell relative to the cyclist, when the bell is mounted on a handlebar of a bicycle. Therefore, the terms “front” and “rear” are relative to an arrangement facing the cyclist and opposite the cyclist respectively, the “front” position in particular being shown to the left in FIGS. 1b, 3b, 3c and the “rear” position being shown to the right in the figures. Similarly, the terms “outer” and “inner” are relative to an arrangement that is respectively close to an outer edge of the handlebar, and in particular close to a handle on which a hand is positioned on the bicycle, and close to the centre of the handlebar.

The bell comprises a ringer 1, in addition to a clapper 2 that can be manually moved over a path of travel for stressing a resilient member 3, which is arranged such that it actuates the subsequent displacement of the clapper over a path for striking the bell, both of which being mounted on a base 4 equipped with a clamping collar 5 for clamping the bell about the support thereof.

The collar 5 can be formed in one piece with the base 4, for example by the injection and moulding of a plastic material, in particular polyamide (PA).

The collar 5 comprises a first end 5a secured to the base 4 and a second end 5b that is equipped with a fastening means to allow the collar 5 to be positioned in a state in which it is clamped about the support.

In the embodiment shown, the collar 5 has a flexible strap extending between the two ends thereof, and the free end 5b has a tip 6 that supports the fastening means. In particular, the strap has a U-shaped geometry on which the tip 6 is positioned in order to close the collar 5 about the support.

The base 4 has a housing 7 in which the tip 6 is positioned when the collar 5 is in the state in which it is clamped about the support, the housing being positioned underneath a plate 8 on which the bell is positioned in a fixed state. In particular, the arrangement of the tip 6 in the housing 7 improves the compactness of the bell.

With reference to the figures, the base 4 has three vertical walls 4a, 4b that extend beneath the plate 8, and one horizontal wall 4c that extends between the lower sides of the vertical walls, the four walls 4a-4c defining with the plate the housing 7 for receiving the tip 6. The three vertical walls 4a, 4b comprise two sagittal walls 4a that extend symmetrically on either side of a median plane M, each being arranged in a sagittal plane parallel to the median plane, in addition to a front wall 4b that extends in a frontal plane perpendicular to the median plane.

In particular, the housing 7 opens out into a rear opening 7a formed between the rear sides of the sagittal walls 4a in order to allow the tip 6 to be inserted into the housing 7 through the rear opening.

In order to improve the maintenance of the bell on the handlebar, at least the lower sides of the sagittal walls 4a have a curvature 9 intended to mould to at least one portion of the periphery of the handlebar during the assembly of the bell, which reduces the risks of the unwanted sliding of the bell about the handlebar.

With reference to the figures, the front wall 4b has a lower portion 10 that extends beneath the housing 7 and that has a curvature formed in the continuation of the curvatures 9 of the sagittal walls 4a, the first end 5a of the collar 5 being formed integrally in one piece with the lower portion.

Moreover, the ringer 1 comprises an additional fastening means arranged such that it engages with the fastening means of the collar 5 in order to maintain the collar in the state in which it is clamped about the handlebar and to fasten the ringer on the base 4 by means of the collar. In particular, the fastening means is part of the ringer 1 or is permanently fixed to the ringer 1, so as to be handled by the ringer.

Therefore, the bell is fastened onto the handlebar in a simple manner by means of the ringer 1, which allows the fastening to take place in a particularly simple and intuitive manner, even when using the bicycle outdoors, since it does not require the use of a tool.

With reference to the figures, the ringer 1 is equipped with a threaded rod 11. In particular, the ringer 1 has a cap 1a surrounded by a peripheral skirt 1b, the cap having an orifice 12 inside of which the rod 11 is fastened by extending inside the skirt. Moreover, the rod 11 has a nut 27 intended to be axially tightened underneath the cap 1a after the fastening of the rod inside the orifice 12, in order to lock the fastening.

The ringer 1 can be made of a metal material, in particular with an aluminium base, and the threaded rod 11 can be a standard screw, for example an M4 screw. In particular, the ringer 1 can be formed by stamping and electroplating, then the threaded rod 11 can be fastened to the cap 1a by stamping, in particular using a press.

Furthermore, the tip 6 is equipped with a threaded orifice 13 into which the threaded rod 11 is intended to be screwed when assembling the bell on the handlebar. In the embodiment shown, a nut 14 is positioned inside the threaded orifice, in particular through an opening 15 formed for this purpose on one side surface of the tip 6.

The plate 8 has an orifice 16, in which the rod 11 is positioned when assembling the ringer 1 thereon, so that the rod is screwed inside the threaded orifice 13 positioned in the housing 7. In particular, the positioning of the tip 6 in the housing 7 allows the stresses for screwing the rod 11 into each of the orifices 13, 16 to be aligned. Moreover, the plate 8 has an indentation 28 formed about the orifice 16 and in which the nut 27 is intended to axially abut, after the positioning of the rod 11 in the orifice.

The housing 7 can advantageously have dimensions arranged so as to allow the tip 6 to be maintained with limited relative displacements, which in particular allows the orifices 13, 16 to be vertically aligned, and thus eases the screwing of the threaded rod 11 inside the threaded orifice 13 during assembly of the ringer 1 onto the plate. In particular, the sagittal walls 4a can be spaced apart by a distance that is substantially equal to the width of the tip 6, in order to allow for the maintenance of the tip between the sagittal walls without any clearance.

Therefore, in order to both assemble the bell and mount the bell on the handlebar, the cyclist positions the clamping collar 5 about a portion of the handlebar, then inserts and holds the tip 6 in the housing 7, in particular using one hand. The cyclist then grasps the ringer 1 with the other hand, holding it by the peripheral skirt 1b thereof, in order to mount it on the base 4 by inserting the rod 11 into the orifice 16 of the plate 8 and opposite the threaded orifice 13 of the tip 6. Finally, the cyclist rotates the ringer 1 about the axis of the rod 11 in order to screw it into the threaded orifice 13, so as to maintain the collar 5 in the state in which it is clamped about the handlebar and to figure the ringer onto the base 4 by means of the collar.

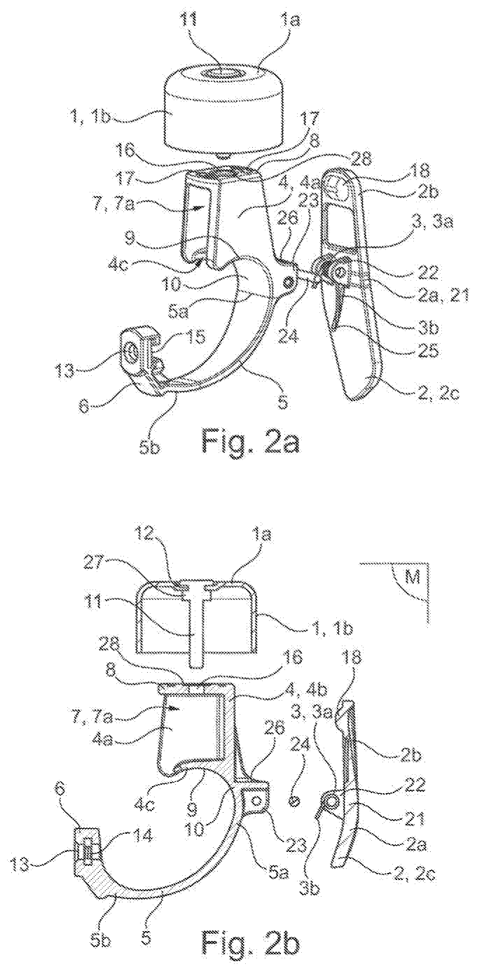

With reference to FIG. 2a, the plate 8 comprises a marking 17, in particular in the form of curved arrows, positioned on either side of the orifice 16, in order to inform the cyclist of the direction in which the ringer 1 must be rotated in order to assemble the bell and figure it onto the handlebar.

Advantageously, the bell can be fastened near a handle of the bicycle, in particular against the brake ring, in order to allow the cyclist to move the clapper 2 using his/her thumb while limiting the loss of grip on the handle, and thus easing the use of the bell when cycling.

The clapper 2 has a central portion 2a that is mounted such that it rotates on the base 4, the central portion being positioned below an upper lug 2b provided with a percussion area 18.

The clapper 2 also has a lower displacement lug 2c provided with an actuating area 29, the resilient member 3 being positioned between the clapper and the base 4 such that a pressing action on the actuating area 29 distances the percussion area 18 from the ringer 1, while stressing the resilient member 3, the release of the pressing action actuating the striking movement generating the striking of the ringer by the percussion area.

The clapper 2 can in particular be formed in one piece with the lugs 2b, 2c and the central portion 2a, for example by the injection and moulding of a plastic material, in particular having a polyoxymethylene (POM) base.

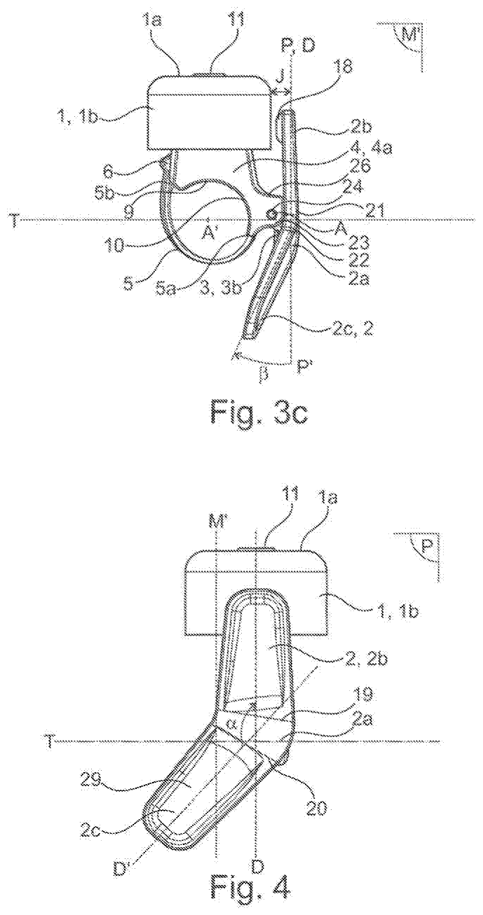

With reference to FIG. 4, the collar 5 is arranged such that it defines an assembly axis A′ of the support, a sagittal assembly plane M′ containing the part of the collar situated the furthest outwards, the part in particular being positioned near the base of a handle of the handlebar, in addition to a transverse plane T perpendicular to the assembly plane M′ and containing the assembly axis A′.

Moreover, the percussion area 18 extends above the transverse plane T, whereas the actuating area 29 extends below the transverse plane, by being offset in the outwards direction relative to the assembly plane M′.

Therefore, advantageously, the actuating area 29 of the clapper 2 is oriented towards a handle of the handlebar, and thus towards a hand of the cyclist, when the bell is mounted on the brake ring of the handle, which allows the actuating area to be brought closer to the thumb, in particular for a small hand of a child, and thus allows the cyclist to press on the actuating area without having to change his/her grip on the handle.

Therefore, the cyclist can use the bell to signal his/her presence while still being able to brake and/or manoeuvre the handlebar using both hands, which guarantees the safety of the cyclist, in particular when this is a child and/or a person learning to ride a bicycle.

In the embodiment shown, the central portion 2a is mounted such that it rotates on the base 4 about a rotational axis A that extends substantially parallel to the assembly axis A′ of the collar 5 about the handlebar, and the upper lug 2b extends in a frontal vertical plane P that is parallel to the rotational and assembly axes.

In particular, the frontal vertical plane P produces a clearance J with the ringer 1, the resilient member 3 being arranged such that the striking path of travel extends over the clearance and such that the upper lug 2b extends in the vertical plane in the absence of any pressing action on the lower lug 2c. Therefore, any unwanted contact between the upper lug 2b and the ringer 1 is prevented, for example in the event of vibrations caused by impacts experienced by the bicycle when in motion, in particular on rough ground.

Furthermore, the dimensions of the clearance J are arranged so as to allow the bell to function correctly. More specifically, if the dimensions of the clearance J are too great, the upper lug 2b will not be able to strike the ringer 1 after the pressing action on lower lug 2c is released, and the bell will not produce any sound. Similarly, if the dimensions of the clearance J are too small, there is a risk of the upper lug 2b striking the ringer 1 multiple times, which will also prevent sound from being generated.

In the figures, the upper lug 2b is equipped with a protuberance 18 on which is formed the percussion area for striking the ringer 1, the dimensions of the clearance J and the maximum thickness of the protuberance being arranged so as to leave a space between the protuberance and the ringer 1, which space is large enough to prevent any unwanted contact as described above between the protuberance and the ringer.

Moreover, the actuating area 29 of the lower lug 2c can have an indentation for positioning a thumb, so as to provide the cyclist with a visual and/or tactile marker allowing him/her to optimally position his/her thumb in the actuating area, and thus ensure the correct actuation of the bell.

With reference to FIG. 4, the upper lug 2b extends in the vertical plane P in a direction D that is perpendicular to the rotational axis A of the clapper 2. Moreover, the lower lug 2c extends in a direction D′ forming, with the direction D of the upper lug 2b, an angle α measured in the frontal vertical plane P that is strictly less than 180°, and in particular that lies in the range 120° to 160°.

In the embodiment shown, the lower lug 2c also extends in a plane P′ that forms a non-zero angle β in the rear-facing direction with the frontal vertical plane P. Notably, the angle β can in particular lie in the range 10° to 30°.

As shown in particular in FIG. 4, the central portion 2a has an elbow-shaped geometry respectively connecting the lower 19 and upper 20 edges of the upper 2b and lower 2c lugs. Moreover, the central portion 2a has an upper section 21 that is vertically aligned with the upper lug 2b and that is equipped with means 22 for assembling the clapper 2 such that it rotates on the base 4.

In the embodiment shown, the upper section 21 has a hinge element 22 forming means for assembling the clapper 2 such that it rotates on the base 4, and that complements a hinge element 23 of the base 4, a rotation pin 24 being positioned in the assembly of the hinge elements.

Moreover, the resilient member 3 comprises a spring wire having a winding 3a that is immobilised relative to the base 4, in particular by being positioned around the pin 24, and axially inserted between the hinge elements 22, 23, in addition to one end 3b that is at rest against the lower lug 2c so as to move therewith in order to stress the winding.

In particular, the lower lug 2c comprises an indentation 25, the shape of which complements that of the end 3b of the spring 3, and wherein the end is positioned in abutment, in order to prevent any unwanted relative sliding of the end relative to the lower lug.

Advantageously, the lower portion 10 of the front wall 4b has a front lateral extension 26 under which the hinge element 23 is formed, in order to allow the central portion 2a of the clapper 2 to be mounted on the lateral extension such that it rotates under stress from the spring 3.

Therefore, the rotational axis of the clapper 2 is laterally offset, in particular towards the front, relative to the base 4, and therefore relative to the ringer 1, and the lower lug 2c is brought closer to the cyclist's thumb, which further improves the ergonomics of using the bell.

What is claimed is:

1. A percussion bell configured to be secured to a support, the bell comprising a ringer and a clapper mounted on a base equipped with a clamping collar for clamping the bell about the support, the collar being arranged that it defines an assembly axis of the support, a sagittal assembly plane containing the part of the collar located the furthest outwards, in addition to a transverse plane perpendicular to the assembly plane and containing the assembly axis, the clapper being configured for being manually movable over a path of travel for stressing a resilient member that is configured to actuate the subsequent displacement of the clapper over a path for striking the ringer, the clapper having a central portion that is mounted and rotatable on the base, the central portion being positioned below an upper lug provided with a percussion area, the clapper also having a lower displacement lug provided with an actuating area, the resilient member being positioned between the clapper and the base that a pressing action on the actuating area distances the percussion area from the ringer, while stressing the resilient member, the release of the pressing action actuating the striking movement generating the striking of the ringer by the percussion area, the bell wherein the percussion area extends above the transverse plane, the actuating area extending below the transverse plane by being offset in the outwards direction relative to the assembly plane.

2. The percussion bell according to claim 1, wherein the central portion is rotatable on the base about an axis, the upper lug extending in a vertical plane in a direction that is perpendicular to the rotational axis.

3. The percussion bell according to claim 2, wherein the lower lug extends in a direction forming, with the direction of the upper lug, an angle measured in the vertical plane that is strictly less than 180°.

4. The percussion bell according to claim 1, wherein the central portion has an elbow-shaped geometry respectively connecting the lower and upper edges of the upper and lower lugs.

5. The percussion bell according to claim 1, wherein the central portion has an upper section that is vertically aligned with the upper lug, the upper section being configured for assembling the clapper rotatably on the base.

6. The percussion bell according to claim 1, wherein the upper lug extends in a vertical plane, the lower lug extends in a plane that forms a non-zero angle in the rear-facing direction with the vertical plane, the angle lying in the range 10° to 30°.

7. The percussion bell according to claim 1, wherein the clapper is formed in one piece with the lugs and the central portion.

8. The percussion bell according to claim 1, wherein the upper lug is equipped with a protuberance on which is formed the percussion area for striking the ringer.

9. The percussion bell according to claim 1, wherein the actuating area of the lower lug has an indentation for positioning a thumb.

10. The percussion bell according to claim 1, wherein the upper lug extends in a vertical plane that produces a clearance with the ringer, the resilient member being arranged such that the striking path of travel extends over the clearance and that the upper lug extends in the vertical plane in the absence of any pressing action on the lower lug.

11. The percussion bell according to claim 1, wherein the central portion has a hinge element that complements a hinge element of the base, a rotation pin being positioned in the assembly of the hinge elements.

12. The percussion bell according to claim 1, wherein the resilient member comprises a spring wire having a winding that is immobilised relative to the base, and one end that is at rest against the lower lug to move therewith in order to stress the winding.

13. The percussion bell according to claim 1, wherein the base has a lateral extension on which the central portion of the clapper is mounted such that it rotates under stress from the resilient member.

14. The percussion bell according claim 1, wherein the central portion is mounted such that it rotates on the base about an axis that extends substantially parallel to the assembly axis.

15. The percussion bell according to claim 1, wherein the collar comprises a first end secured to the base and a second free end that is equipped with a first fastener, the ringer comprising a second fastener, the engagement of which with the first fastener of the collar is arranged to maintain the collar in the state in which it is clamped about the support and to fasten the ringer on the base by means of the collar.
